(19) United States
(12) Patent Application Publication
(10) Pub. No.: US 2026/0184565 A1
(43) Pub. Date: Jul. 2, 2026

(54) PURIFICATION OF HYDROGEN REMOVED FROM UNDERGROUND STORAGE

(71) Applicant: UOP LLC, Rosemont, IL (US)

(72) Inventors: Rajasi Shukre, Bloomingdale, IL (US); Shubhra J. Bhadra, Naperville, IL (US); Eleftherios Adamopoulos, Gurnee, IL (US); Bradley P. Russell, Carol Stream, IL (US)

(21) Appl. No.: 19/436,828

(22) Filed: Dec. 30, 2025

Related U.S. Application Data
(60) Provisional application No. 63/740,656, filed on Dec. 31, 2024.

(51) Int. Cl. C01B 3/56; B01D 53/047; B01D 53/32

(52) U.S. Cl. CPC C01B 3/56; B01D 53/047; B01D 53/326; B01D 2253/102; B01D 2253/116; B01D 2256/16; C01B 2203/042; C01P 2006/80

(57) ABSTRACT

A process for recovery of hydrogen from underground storage is provided. The process involves sending a hydrogen stream stored in an underground cavern to a pressure swing adsorption unit and then to an electrochemical compression unit to produce hydrogen having a purity of above 99.5 mol % to close to 100 mol %.

### FIELD OF THE INVENTION

This invention generally relates to a process for maximizing hydrogen recovery especially from underground storage.

### BACKGROUND

Interest has increased into the use of renewable sources such as wind, solar and hydro energy to produce electricity. However, the fluctuating nature of electricity produced from such sources requires a bulk energy storage system to store energy as a buffy and to allow for demand to be met constantly. Underground storage of hydrogen is becoming a proven way to store a huge amount of energy underground after hydrogen has been produced since hydrogen has a higher energy content per unit than other gases such as methane and natural gas. The hydrogen may be stored underground in depleted hydrocarbon reservoirs, aquifers and manmade underground cavities such as salt caverns. The hydrogen may mix with impurities during storage or there may be other gases that are present as having been added to the hydrogen gas for other purposes. It is necessary to be able to recover the hydrogen and to purify the gas to the specified level depending upon the end use.

### SUMMARY OF THE INVENTION

A process is provided for the purification of a hydrogen-rich stream that has been kept in underground storage facilities such as salt caverns. The feed purity of the hydrogen stream from the storage facility can range from 97.76 mol % to 99.76 mol %. The other contaminants in the feed can consist of methane, nitrogen, carbon dioxide, argon and hydrogen sulfide. The hydrogen product purity obtained from the purification process can range from 99.5 mol % (industrial grade) to 99.97 mol % (fuel cell grade). The purification is done by a combination of a pressure swing adsorption unit and an electrochemical compressor. The stored gas is first sent to the pressure swing adsorption unit, compressed and sent to an electrochemical compressor. The permeate comprising purified hydrogen is compressed and returned to the stream sent to the pressure swing adsorption unit. The purified product gas is then sent to be used to produce energy such as in fuel cells or for industrial purposes.

### BRIEF DESCRIPTION OF THE DRAWINGS

FIG. 1 shows the use of an electrochemical compressor in the purification of hydrogen in addition to a pressure swing adsorption unit used in FIG. 1.

### DEFINITIONS

As used herein, the term “stream” can include various hydrocarbon molecules, such as straight-chain, branched, or cyclic alkanes, alkenes, alkadienes, and alkynes, and optionally other substances, such as gases, e.g., hydrogen, or impurities, such as heavy metals, carbon oxides, and sulfur and nitrogen compounds. The stream can also include aromatic and non-aromatic hydrocarbons. Moreover, the hydrocarbon molecules may be abbreviated C1, C2, C3 . . . Cn where “n” represents the number of carbon atoms in the one or more hydrocarbon molecules. Furthermore, a superscript “+” or “−” may be used with an abbreviated one or more hydrocarbons notation, e.g., C3⁺ or C3⁻, which is inclusive of the abbreviated one or more hydrocarbons. As an example, the abbreviation “C3⁺” means one or more hydrocarbon molecules of three carbon atoms and/or more. A “stream” may also be or include substances, e.g., fluids or substances behaving as fluids, other than hydrocarbons, such as air, hydrogen, or catalyst.

As used herein, the term “zone” can refer to an area including one or more equipment items and/or one or more sub-zones. Equipment items can include one or more reactors or reactor vessels, heaters, exchangers, pipes, pumps, compressors, and controllers. Additionally, an equipment item, such as a reactor, dryer, or vessel, can further include one or more zones or sub-zones.

As used herein, the term “rich” can mean an amount of at least generally about 50%, and preferably about 70%, by mole, of a compound or class of compounds in a stream.

As used herein, the term “substantially” can mean an amount of at least generally about 80%, preferably about 90%, and optimally about 99%, by mole, of a compound or class of compounds in a stream.

As used herein, the terms “adsorbent” and “adsorber” include, respectively, an absorbent and an absorber, and relates, but is not limited to, adsorption, and/or absorption.

As used herein, the term “liquid hourly space velocity” can be defined as volumes of fresh charge stock per hour per volume of catalyst particles in the reaction zone and be abbreviated “LHSV”.

As used herein, the term “hour” may be abbreviated “hr”, the term “kilogram” may be abbreviated “kg”, the term “kilopascal” may be abbreviated “KPa”, and the terms “degrees Celsius” may be abbreviated “° C.”. All pressures are absolute.

As depicted, process flow lines in the figures can be referred to interchangeably as, e.g., lines, pipes, feeds, effluents, products, portions, remainders, discharges, or streams.

### DETAILED DESCRIPTION

The present disclosure is directed to a process for the purification of hydrogen rich stream sourced from underground storage facilities such as salt caverns. The feed purity of the hydrogen stream from the storage facility can range from 97.76 mol % to 99.76 mol %. The other contaminants in the feed can consist of methane, nitrogen, carbon monoxide, carbon dioxide, water, argon and hydrogen sulfide. The hydrogen product purity obtained from the purification process is substantially increased and can range from 99.5 mol % (industrial grade) to 99.97 mol % (fuel cell grade). The flow schemes employed consist of two purification blocks, which operate continuously. The first block is a pressure-swing adsorption unit. The effluent stream/tail gas of the pressure swing adsorption system contains hydrogen ranging from 70 mol % to 98 mol %. This stream is sent to one or more electrochemical compressors. Thus, the product stream is a high purity hydrogen stream, which is close to the feed purity of the underground hydrogen storage facility. The low pressure stream may be compressed and mixed with the feed gas from the storage facility. The mixed stream is fed to the PSA unit. The process parameters of the configuration can be optimized to achieve a net hydrogen recovery of 99%+ with respect to the underground storage feed gas, for the range of the specified feed conditions.

The feed pressure to the pressure swing adsorption unit may range up to 60 bara. The operating temperature of the PSA unit may range from about 40° C. to 57° C. in the present application. The feed from the underground storage facility is mixed with a permeate stream of a downstream membrane purification system and the resulting mixed stream is fed to the PSA unit. The PSA tail gas pressure can range from 1.3 bara to 4.5 bara. Each PSA unit may have one or two adsorbent layers such as activated carbon with a top layer of a molecular sieve. Since the feed stream has a high purity of hydrogen, the PSA unit normally utilizes at the most two adsorbent layers. This makes it convenient to utilize the radial flow configuration as it is easy to load the adsorbent in the bed. Moreover, with the elimination of the hydraulic limitation and the possibility of enhancing kinetics, the PSA unit can be optimized further.

Suitable adsorbents can include one or more crystalline molecular sieves, activated carbons, activated clays, silica gels, activated aluminas, and combinations thereof. Preferably, the adsorbents are one or more of an activated carbon, an alumina, an activated alumina, and a silica gel. An exemplary PSA zone is disclosed in, e.g., U.S. Pat. No. 5,332,492.

The concentration of hydrogen in the product may be maximized to about 100% by use of electrochemical hydrogen compressors. Electrochemical hydrogen compressors (EHCs) are devices that use an electrochemical principle to compress lower-pressure hydrogen into higher pressure hydrogen in which the application of voltage can lead to the generation of localized pressure difference due to hydrogen oxidation at anodes and hydrogen reduction at cathodes. Protons and electrons produced through hydrogen oxidation are transported to the cathode side through a proton exchange membrane for protons and an external path for electrons to recombine to form new hydrogen molecules in which electric power is converted to chemical potential in high-pressure hydrogen gas through the electrochemical process. As a result, EHC systems are analogous to proton exchange membrane fuel cells and contain proton exchange membranes, catalyst layers, gas diffusion layers, flow field plates and end plates.

A process for recovery of hydrogen from underground storage comprising obtaining a hydrogen feed stream from underground storage wherein said hydrogen is at a temperature from about 40-60° C. and a pressure from about 30 to 80 bara, sending said hydrogen feed stream to a pressure swing adsorption unit to produce a product stream comprising a greater percentage of hydrogen than said hydrogen feed stream and a tail gas comprising a lower percentage of hydrogen than said hydrogen feed stream; compressing said tail gas and then sending a compressed tail gas stream to an electrochemical compression unit to produce a permeate stream having a higher percentage of hydrogen than said compressed tail gas stream and a retentate gas stream; and then combining said permeate stream with said hydrogen feed stream. The hydrogen feed stream may be at a pressure of from about 40 to 60 bara and temperature from about 40-60 C. The hydrogen feed stream comprises from about 90 mol % to 99.76 mol % hydrogen and preferably about 97.76 mol % to about 99.76 mol % hydrogen. The tail gas has a pressure from about 1.3 to 14.5 bara. The pressure swing adsorption unit contains a maximum of two layers of adsorbent selected from activated carbon and molecular sieve.

The compressed tail gas stream has a pressure of up to 14 bara. The compressed tail gas stream comprises from about 70 mol % to 98 mol % hydrogen. The stream from the electrochemical compressor may be compressed to match the pressure of said hydrogen feed stream. The permeate stream comprises from about 97 mol % to 99 mol % hydrogen. The retentate stream is sent to a fuel gas header. The once through passage of said hydrogen feed stream results in recovery of at least 80-95 mol % of said hydrogen and preferably a once through passage of said compressed tail gas through said membrane unit recovers from about 90-96 mole % hydrogen. Most preferably the process results in greater than 99 mole % recovery of said hydrogen from said hydrogen feed stream. A portion of the product stream is compressed by an electrochemical compressor. A portion of the permeate stream is compressed by an electrochemical compressor. A portion of the product stream and a portion of the permeate stream are compressed by an electrochemical compressor.

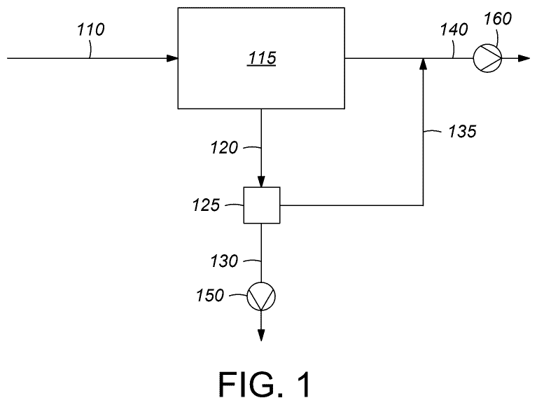

FIG. 1 shows the use of electrochemical compressors that are more efficient in compressing hydrogen than standard mechanical compressors. In a simplified figure, a hydrogen feed gas 110 is sent to a separation unit 115 such as a pressure swing adsorption unit and to remove impurities and produce a product gas 140. A compressor 140 and compressor 150 are optional to provide gas streams at the necessary pressure. A portion of the gas 120 is sent to electrochemical compressor 125 which further separates the gas into purge gas 130 and a compressed product gas 135 to be added to product gas 140. The use of electrochemical compressors increase the efficiency of the process to produce the high purity hydrogen required.

### EXAMPLE

### Example 1

In Example 1, hydrogen is purified from underground storage reservoir such as a salt cavern. Table 1 shows the pressures, temperatures, flow rate and composition at points A, B and C in which point A is the gas from the reservoir, B is the tail gas from the PSA unit and C is the hydrogen product stream after passing through the EHC unit.

TABLE 1

| Stream | A | B | C |
|---|---|---|---|
| T (° C.) | 57 | 51 | 57 |
| Flow (Nm³/h) | 112,761 | 8133 | 8125 |
| Composition mol % | | | |
| Hydrogen | 97.424 | 70.646 | 99.99 |
| Methane | 1.630 | 19.823 | |
| CO2 | 0.100 | 1.382 | |
| Nitrogen | 0.390 | 2.817 | |
| Argon | 0.100 | 0.391 | |
| Water | 0.356 | 4.941 | |
| Total | 100.000 | 100.000 | |

### SPECIFIC EMBODIMENTS

While the following is described in conjunction with specific embodiments, it will be understood that this description is intended to illustrate and not limit the scope of the preceding description and the appended claims.

A first embodiment of the invention is a process for recovery of hydrogen comprising obtaining a hydrogen feed stream, sending the hydrogen feed stream after pretreatment and a pressure reduction step to a pressure swing adsorption unit to produce a product stream comprising a greater percentage of hydrogen than the hydrogen feed stream and a tail gas comprising a lower percentage of hydrogen than the hydrogen feed stream; and then sending the tail gas stream to an electrochemical compression unit to produce a compressed product gas stream having a higher percentage of hydrogen than the tail gas stream and a purge gas stream; and then combining the compressed product gas stream with the product stream. An embodiment of the invention is one, any or all of prior embodiments in this paragraph up through the first embodiment in this paragraph wherein the pressure swing adsorption unit is at a temperature from about 30-60° C. An embodiment of the invention is one, any or all of prior embodiments in this paragraph up through the first embodiment in this paragraph wherein the tail gas has a pressure from about 1.2 to 7 bara. An embodiment of the invention is one, any or all of prior embodiments in this paragraph up through the first embodiment in this paragraph wherein the pressure swing adsorption unit comprises multiple layers of adsorbents selected from activated carbon, silica gel, alumina and molecular sieves. An embodiment of the invention is one, any or all of prior embodiments in this paragraph up through the first embodiment in this paragraph wherein the compressed tail gas stream has a pressure of about 7 bara to at least 95 bara. An embodiment of the invention is one, any or all of prior embodiments in this paragraph up through the first embodiment in this paragraph wherein the compressed tail gas stream comprises from about 10 mol % to about 90 mol % hydrogen. An embodiment of the invention is one, any or all of prior embodiments in this paragraph up through the first embodiment in this paragraph wherein the product stream comprises from about 85 mol % to about 99.99 mol % hydrogen. An embodiment of the invention is one, any or all of prior embodiments in this paragraph up through the first embodiment in this paragraph wherein a once through the pressure swing adsorption unit of the hydrogen feed stream results in recovery of at least 90 mol % of the hydrogen. An embodiment of the invention is one, any or all of prior embodiments in this paragraph up through the first embodiment in this paragraph wherein a once through passage of the compressed tail gas through the electrochemical compressor recovers from about 95-99.99 mole % hydrogen. An embodiment of the invention is one, any or all of prior embodiments in this paragraph up through the first embodiment in this paragraph wherein a once through passage of the compressed tail gas through the electrochemical compressor recovers from about 98-99 mole % hydrogen. An embodiment of the invention is one, any or all of prior embodiments in this paragraph up through the first embodiment in this paragraph wherein the process results in at least 99 mol % recovery of the hydrogen from the hydrogen feed stream.

Without further elaboration, it is believed that using the preceding description that one skilled in the art can utilize the present invention to its fullest extent and easily ascertain the essential characteristics of this invention, without departing from the spirit and scope thereof, to make various changes and modifications of the invention and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

In the foregoing, all temperatures are set forth in degrees Celsius and, all parts and percentages are by weight, unless otherwise indicated.

1. A process for recovery of hydrogen comprising obtaining a hydrogen feed stream, sending said hydrogen feed stream after pretreatment and a pressure reduction step to a pressure swing adsorption unit to produce a product stream comprising a greater percentage of hydrogen than said hydrogen feed stream and a tail gas comprising a lower percentage of hydrogen than said hydrogen feed stream; and then sending the tail gas stream to an electrochemical compression unit to produce a compressed product gas stream having a higher percentage of hydrogen than said tail gas stream and a purge gas stream; and then combining said compressed product gas stream with said product stream.

2. The process of claim 1 wherein said pressure swing adsorption unit is at a temperature from about 30-60° C.

3. The process of claim 1 wherein said tail gas has a pressure from about 1.2 to 7 bara.

4. The process of claim 1 wherein said pressure swing adsorption unit comprises multiple layers of adsorbents selected from activated carbon, silica gel, alumina and molecular sieves.

5. The process of claim 1 wherein the compressed tail gas stream has a pressure of about 7 bara to at least 95 bara.

6. The process of claim 1 wherein said compressed tail gas stream comprises from about 10 mol % to about 90 mol % hydrogen.

7. The process of claim 1 wherein said product stream comprises from about 85 mol % to about 99.99 mol % hydrogen.

8. The process of claim 1 wherein a once through said pressure swing adsorption unit of said hydrogen feed stream results in recovery of at least 90 mol % of said hydrogen.

9. The process of claim 1 wherein a once through passage of said compressed tail gas through said electrochemical compressor recovers from about 95-99.99 mole % hydrogen.

10. The process of claim 1 wherein a once through passage of said compressed tail gas through said electrochemical compressor recovers from about 98-99 mole % hydrogen.
